(19) United States
(12) Patent Application Publication
(10) Pub. No.: US 2003/0002170 A1
(43) Pub. Date: Jan. 2, 2003

(54) Imaging lens and image reading apparatus using the same

(75) Inventor: Tadao Hayashide, Tochigi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/117,124

(22) Filed: Apr. 8, 2002

(30) Foreign Application Priority Data
Apr. 10, 2001 (JP) 110996/2001(PAT.)

(51) Int. Cl. G02B 13/08

(52) U.S. Cl. 359/668; 359/671

(57) ABSTRACT

The present invention has as its object to provide an imaging lens which can read image information highly accurately even if there are changes in environmental conditions such as temperature, humidity and atmospheric pressure, and an image reading apparatus using the same. To achieve this object, in an imaging lens for imaging the image information of an original on reading means, at least one of a plurality of lenses constituting the imaging lens is a lens anamorphic with respect to the optical axis thereof, and when the temperature change factor dN/dT (1/° C.) of the refractive index dN of the anamorphic lens for e-line at the use temperature dT is defined as C_{T}, and the focal length (mm) of the anamorphic lens for e-line is defined as fₐₙₘ, the condition that |C_{T}/fₐₙₘ|≦4.30×10⁻⁶ is satisfied.

### BACKGROUND OF THE INVENTION

1. Field of the Invention

This invention relates to an imaging lens and an image reading apparatus using the same, and particularly is suitable for an apparatus such as an image scanner, a digital copying machine or a facsimile apparatus adapted to read the image information of an original with high accuracy by the use of a one-dimensional or two-dimensional image sensor such as a CCD.

2. Related Background Art

In a digital reading apparatus such as a digital copying machine or an image scanner for reading and converting the image information of an original and converting it into an electrical signal to thereby enable the image information of the original to be handled as electronic information, it is generally practised to sequentially scan an original illuminated by an illuminating system (illuminating device) by an imaging lens (reading lens) and cause it to be imaged on the surface of a photoelectric conversion element such as a CCD (line sensor).

FIG. 8 of the accompanying drawings is a schematic view of the essential portions of a flat bed type image reading apparatus (image scanner) according to the prior art.

In FIG. 8, a beam emitted from illuminating means 808 illuminates an original 801 directly or through the intermediary of a reflector 809, and the reflected beam from the original 801 has its optical path bent in a carriage 806 through the intermediary of first, second, third and fourth reflecting mirrors 803a, 803b, 803c and 803d, and is imaged on the surface of a linear image sensor 805 (hereinafter referred to as the “CCD”) such as a one-dimensional CCD by an imaging lens 804. The carriage 806 is moved in the direction of arrow A (the sub scanning direction) by a sub scanning motor 807 to thereby read the image information of the original 801. The CCD 805 in FIG. 8 comprises a plurality of light receiving elements arranged in a one-dimensional direction (the main scanning direction).

In the construction shown in FIG. 8, to make the entire image scanner compact, the downsizing of the carriage 806 is necessary. To downsize the carriage, there is a method such as increasing the number of the reflecting mirrors or reflecting the beam by a single reflecting mirror a plurality of times to thereby secure an optical path length.

In these methods, however, the internal structure of the carriage 806 becomes complicated and therefore, assembling accuracy becomes severe and cost rises greatly. Also, imaging performance is aggravated in proportion to the surface accuracy and reflection frequency of the reflecting mirror, and this also leads to the problem that the read image is affected.

On the other hand, there can also be applied a method of widening the angle of field of the imaging lens (imaging system) 804 and shortening the distance between object images. As an imaging lens of a wide angle of field realized by a realistic number of lenses and in a spherical shape, there have heretofore been proposed various types. In any of them, however, the order of 25 degrees as a half angle of field is the upper limit, and when the angle of field is made wider than that, curvature of image field and astigmatism have become great and sufficient performance could not be displayed.

In view of the above-noted problem, the applicant has already proposed in Japanese Patent Application Laid-Open No. 2000-171705 a technique of introducing into an imaging lens an anamorphic lens having at least one anamorphic surface to thereby solve the above-noted problem.

Generally it is difficult to manufacture a lens having an anamorphic surface by grinding and polishing with a glass material. Therefore it is strongly desired to mold it by the use of a resin material or the like.

However, a lens using a material such as resin of which the refractive index is sensitive to temperature suffers from the occurrence of the movement of the focus or the inclination of the focal plane by temperature.

Further, in a lens having rotation-asymmetrical power relative to the optical axis thereof, the above-mentioned movement of the focus or the inclination of the focal plane occurs differently in the main scanning direction and the sub scanning direction.

Particularly, in the image reading apparatus, a heat generating source such as an illuminating light source, a reading element such as a CCD, and a motor exist near the lens and therefore, these problems have appeared remarkably and the temperature dependency of read images has been high.

### SUMMARY OF THE INVENTION

The present invention has as its object to provide an imaging lens which can read image information highly accurately even if there are any changes in environmental conditions such as temperature, humidity, atmospheric pressure, etc., and an image reading apparatus using the same.

One aspect of the present invention is to provide an imaging lens for imaging the image information of an original on reading means, characterized in that at least one of a plurality of lenses constituting the imaging lens is a lens anamorphic with respect to the optical axis thereof, and when the temperature change factor dN/dT (1/° C.) of the refractive index dN of the anamorphic lens for e-line at the use temperature dT is defined as C_{T} and the focal length (mm) of the anamorphic lens for e-line is defined as fₐₙₘ, the condition that

$$\vert \frac{{C}_{T}}{{f}_{a n m}} \vert \leq 4.30 \times {10}^{- 6}$$

is satisfied.

The above mentioned imaging lens of the present invention is preferably characterized in that when the focal length (mm) of the total system of the imaging lens for e-line is defined as fₐₗₗ, the anamorphic lens satisfies the condition that

$$\vert \frac{{f}_{a l l}}{{f}_{a n m}} \vert \leq 1.10 .$$

The above mentioned imaging lens of the present invention is preferably characterized in that when at the maximum angle of field of the imaging lens, the refractive power in the sub scanning direction for e-line at a position whereat a principal ray of a maximum angle of field passes through the incidence surface of the anamorphic lens is defined as φ_{1S}, and the refractive power in the sub scanning direction for e-line at a position whereat the principal ray of the maximum angle of field passes through the emergence surface of the anamorphic lens is defined as φ₂ₛ, and the refractive power in the main scanning direction for e-line at the position whereat the principal ray of the maximum angle of field passes through the incidence surface of the anamorphic lens is defined as φ₁ₘ, and the refractive power in the main scanning direction for e-line at the position whereat the principal ray of the maximum angle of field passes through the emergence surface of the anamorphic lens is defined as φ₂ₘ, and the lens thickness of the anamorphic lens on the optical axis thereof is defined as d, the anamorphic lens satisfies the condition that

|fₐₙₘ((φ₁ₛ+φ₂ₛ−dφ₁ₛφ₂ₛ)−(φ₁ₘ+φ₂ₘ−dφ₁ₘφ₂ₘ))|≦0.33.

One aspect of the present invention is to provide an image reading apparatus using the aforedescribed imaging lens to form the image information of the original on the surface of the reading means.

### BRIEF DESCRIPTION OF THE DRAWINGS

FIG. 1 is a cross-sectional view of a lens according to Numerical Value Embodiment 1 of the present invention.

FIG. 2 is a cross-sectional view of a lens according to Numerical Value Embodiment 2 of the present invention.

FIG. 3 is a cross-sectional view of a lens according to Numerical Value Embodiment 3 of the present invention.

FIG. 4 shows the aberrations of Numerical Value Embodiment 1 of the present invention.

FIG. 5 shows the aberrations of Numerical Value Embodiment 2 of the present invention.

FIG. 6 shows the aberrations of Numerical Value Embodiment 3 of the present invention.

FIG. 7 is a schematic view of essential portions when the imaging lens of the present invention is applied to the image reading apparatus of an image scanner.

FIG. 8 is a schematic view of essential portions when an imaging lens according to the prior art is applied to the image reading apparatus of an image scanner.

### DESCRIPTION OF THE PREFERRED EMBODIMENTS

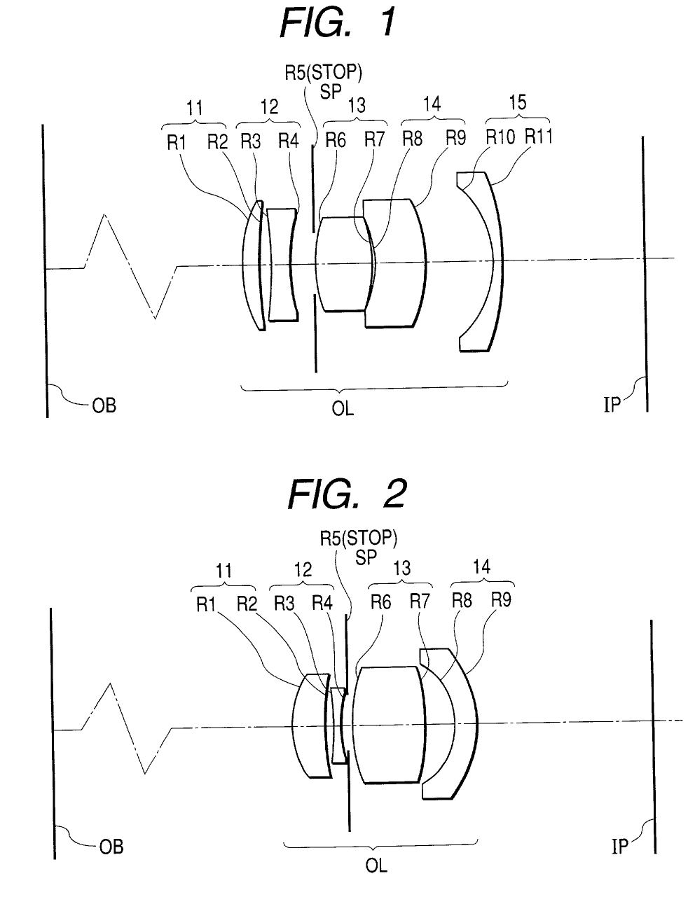

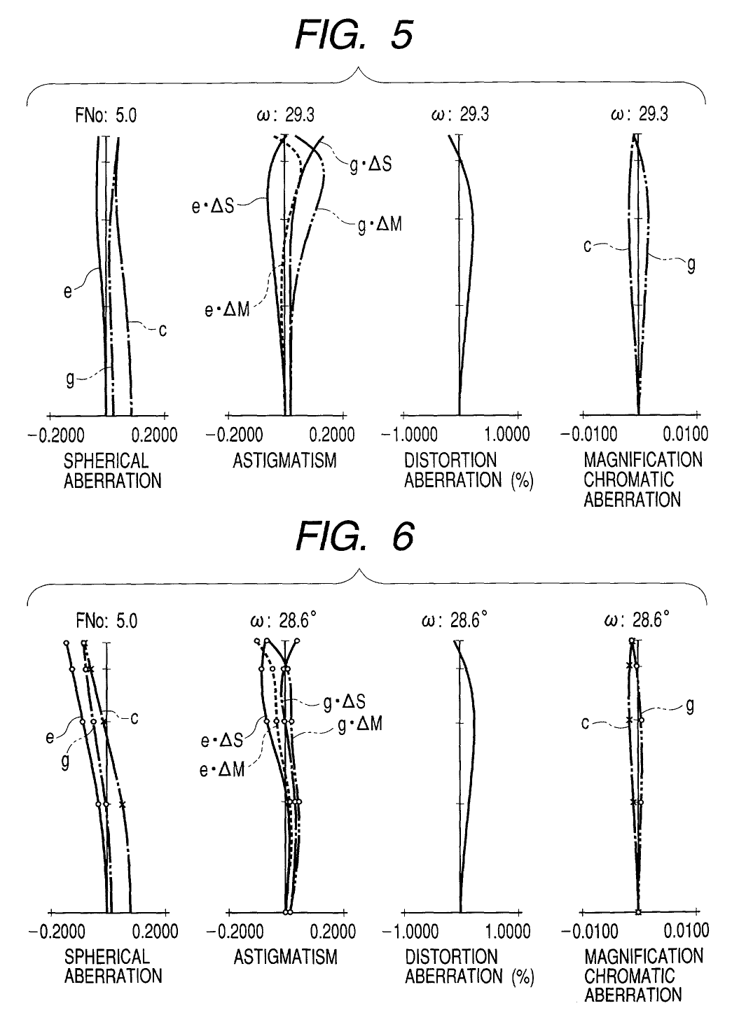

FIGS. 1, 2 and 3 are cross-sectional views of imaging lenses according to Numerical Value Embodiments 1, 2 and 3, respectively, of the present invention which will be described later, and FIGS. 4, 5 and 6 show the aberrations (spherical aberration, astigmatism, distortion aberration and magnification chromatic aberration) of Numerical Value Embodiments 1, 2 and 3, respectively, of the imaging lens of the present invention.

In the cross-sectional views of the lenses, the left side is an enlargement side (a side longer in the conjugate point) which is an original surface OB side (a side on which an image to be read is provided), and the right side is a reduction side (a side shorter in the conjugate point) which is an image plane IP side (a side on which for example, a CCD as a photoelectric conversion element is provided).

OL designates the imaging lens, and OB denotes an original surface (object surface) on which image information to be read is formed. IP designates an image plane on which image pickup means such as a CCD or a photosensitive surface is placed.

The imaging lens OL reduction-images the image information of the original surface OB on the image pickup means IP, and the image information is read by the image pickup means IP.

The imaging lens OL in FIG. 1 is comprised of a telephoto type having, in succession from the original surface OB side, five lenses, i.e., a meniscus-shaped first lens 11 of positive refractive power (hereinafter simply referred to as “positive”) having its convex surface facing the original surface OB side, a biconcave second lens 12 of negative refractive power (hereinafter simply referred to as “negative”), a stop SP, a biconvex positive third lens 13, a meniscus-shaped negative fourth lens 14 having its convex surface facing the image plane IP side, and a meniscus-shaped negative fifth lens 15 having its convex surface facing the image plane IP side.

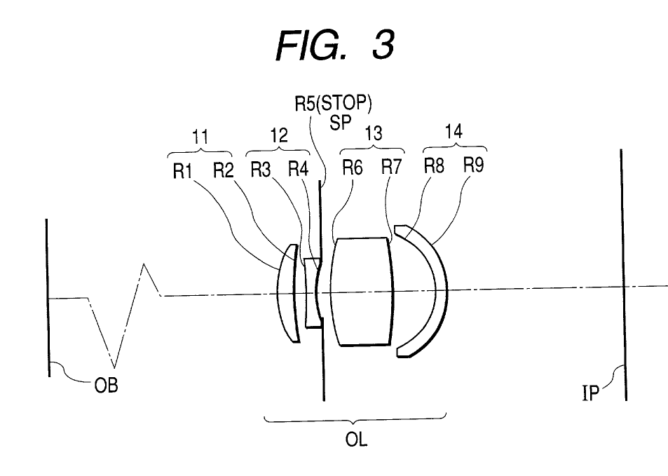

Each of the imaging lenses OL in FIGS. 2 and 3 is comprised of a telephoto type having, in succession from the original surface OB side, four lenses, i.e., a meniscus-shaped positive first lens 11 having its convex surface facing the original surface OB side, a biconcave negative second lens 12, a stop SP, a biconvex positive third lens 13 and a meniscus-shaped negative fourth lens 14 having its convex surface facing the image plane IP side.

The imaging lens OL of the present invention has in a lens system an anamorphic lens rotation-asymmetrical with respect to the optical axis thereof, and this anamorphic lens is formed of a material such as resin of which the refractive index is greatly fluctuated by a temperature change.

<Numerical Value Embodiment 1>

In Numerical Value Embodiment 1, an anamorphic lens is used as the fifth lens 15. As regards the aberrations of Numerical Value Embodiment 1, as shown in FIG. 4, the meridional image plane and the sagittal image plane are both corrected well and astigmatism is small. Further, the other aberrations than curvature of image field and astigmatism are also corrected well.

The anamorphic lens in Numerical Value Embodiment 1 uses resin of which the temperature change factor C_{T} at 25° C. is −1.2×10⁻⁴/° C. when the temperature change factor dN/dT (1/° C.) of the refractive index dN of the anamorphic lens for e-line at the use temperature T (e.g. 0° C. to 50° C.) is defined as C_{T}. As such resin, there is, for example, amorphous polyolefinic resin.

Also, when the focal length (mm) of the anamorphic lens for e-line is defined as fₐₙₘ, the condition that

$$\vert \frac{{C}_{T}}{{f}_{a n m}} \vert \leq 4.30 \times {10}^{- 6} \qquad ( A )$$

is satisfied. In Numerical Value Embodiment 1, the value of conditional expression (A) is sufficiently small, i.e., 56×10⁻⁶, whereby the movement of the focus in an environment changing in temperature is reduced.

Also, when the focal length (mm) of the total system of the imaging lens for e-line is defined as fₐₗₗ, the condition that

$$\vert \frac{{f}_{a l l}}{{f}_{a n m}} \vert \leq 1.10 \qquad ( B )$$

is satisfied. In Numerical Value Embodiment 1, the value of conditional expression (B) is as small as 0.91, whereby not only the movement of the focus but also the inclination of the focal plane is reduced.

Also, when the refractive power in the sub scanning direction for e-line at a position whereat a principal ray of a maximum angle of field passes through the incidence surface of the anamorphic lens is defined as φ₁ₛ, and the refractive power in the sub scanning direction for e-line at a position whereat the principal ray of the maximum angle of field passes through the emergence surface of the anamorphic lens is defined as φ₂ₛ, and the refractive power in the main scanning direction for e-line at the position whereat the principal ray of the maximum angle of field passes through the incidence surface of the anamorphic lens is defined as φ₁ₘ, and the refractive power in the main scanning direction for e-line at the position whereat the principal ray of the maximum angle of field passes through the emergence surface of the anamorphic lens is defined as φ₂ₘ, and the lens thickness of the anamorphic lens on the optical axis thereof is defined as d, the condition that

|fₐₙₘ((φ₁ₛ+φ₂ₛ−dφ₁ₛφ₂ₛ)−(φ₁ₘ+φ₂ₘ−dφ₁ₘφ₂ₘ))|≦0.33 (C)

is satisfied. In Numerical Value Embodiment 1, the value of conditional expression (C) is 0.27, whereby the problem that the inclination of the focal plane occurs differently in the main scanning direction and the sub scanning direction is solved.

The technical meanings of conditional expressions (A) to (C) will now be described.

Conditional expression (A) relates to the ratio between the temperature change factor C_{T} of the refractive index and the focal length fₐₙₘ of the anamorphic lens at the use temperature thereof, and if conditional expression (A) is departed from, it will become difficult to use such a material as resin which is great in the change in refractive index by any temperature change, and this is not good.

Conditional expression (B) relates to the ratio between the focal length fₐₗₗ of the total system of the imaging lens and the focal length fₐₙₘ of the anamorphic lens, and if conditional expression (B) is departed from, the movement of the focus will become great and the inclination of the focal plane will become great, and this is not good.

Conditional expression (C) prescribes the power in the main scanning direction and the sub scanning direction at the passing positions of the on-axis and off-axis principal rays on the anamorphic lens at the maximum angle of field of the imaging lens, and if conditional expression (C) is departed from, the inclination of the focal plane will occur differently in the main scanning direction and the sub scanning direction, and this is not good.

<Numerical Value Embodiment 2>

Numerical Value Embodiment 2 is of a four-lens construction as a whole, and the fourth lens 14 is an anamorphic lens, and curvature of image field and astigmatism are corrected relatively well.

The anamorphic lens in Numerical Value Embodiment 2 uses resin of which the temperature change factor C_{T} is 1.2×10⁻⁴/° C. at 25° C.

The four-lens construction, as compared with the five-lens construction of Numerical Value Embodiment 1, is small in the degree of freedom of design and therefore becomes shallow in depth of focus and thus, the problems by the temperature change are suppressed more severely.

In Numerical Value Embodiment 2, the value of conditional expression (A) is 2.33×10⁻⁶, the value of conditional expression (B) is 0.61, and the value of conditional expression (C) is 0.15, and all of these numerical values are made sufficiently small so as to satisfy the respective conditional expressions, and sufficient imaging performance is maintained during any temperature change.

<Numerical Value Embodiment 3>

Numerical Value Embodiment 3 is of a four-lens construction as a whole, and that lens surface of the fourth lens 14 which is adjacent to the image plane side is an anamorphic surface. That lens surface of the fourth lens 14 which is adjacent to the original surface side is made into an aspherical surface rotation-symmetrical with respect to the optical axis, whereby in addition to the correction of curvature of image field and astigmatism, the correction of coma is sufficiently made.

The fourth lens 14 having the anamorphic surface in Numerical Value Embodiment 3 uses resin of which the temperature change factor C_{T} is −1.3×10⁻⁴/° C. at 25° C.

In Numerical Value Embodiment 3, the value of conditional expression (A) is 1.46×10⁻⁶, the value of conditional expression (B) is 0.33, and the value of conditional expression (C) is 0.18, and all of these numerical values are made sufficiently small so as to satisfy the respective conditions, and sufficient imaging performance is maintained during any temperature change.

The anamorphic surface according to the present invention has a surface shape in which the meridian shape x and the sagittal shape S are described by the following expressions (1), (2) and (3). The sagittal shape is defined by a cross-section perpendicular to the meridian.

The meridian shape x and the sagittal shape S are represented by:

(coordinate system x: the direction of the optical axis, y: the main scanning direction; z: the sub scanning direction)

$$x = \frac{{y}^{2} / R}{1 + \sqrt{( 1 + {k}_{y} ) {( y / R )}^{2}}} + {B}_{4} {y}^{4} + {B}_{6} {y}^{6} + {B}_{8} {y}^{8} + {B}_{10} {y}^{10} \qquad ( 1 )$$

R: the meridian radius of curvature on the optical axis

k_{y}, B₄, B₆, B₈, B₁₀: aspherical surface coefficients

$$S = \frac{{z}^{2} / {r}^{1}}{1 + \sqrt{1 - ( z / {r}^{1} )}} \qquad ( 2 )$$

where

r¹=r₀(1+D₂y²+D₄y⁴+D₆y⁶+D₈y⁸+D₁₀y¹⁰) (3)

r₀: the sagittal radius of curvature on the optical axis

D₂, D₄, D₆, D₈, D₁₀: aspherical surface coefficients

Also, when the direction of the optical axis is X-axis, and the direction perpendicular to the optical axis is H-axis, and R is the paraxial radius of curvature, and 1+k is a cone constant, and E₄, E₆, E₈ and E₁₀ are aspherical surface coefficients, the aspherical shape of the rotation-symmetrical aspherical surface is represented by the following expression:

$$X = \frac{( 1 / R ) {H}^{2}}{1 + \sqrt{( 1 - ( 1 + k ) {( H / R )}^{2} )}} + {E}_{4} {H}^{4} + {E}_{6} {H}^{6} + {E}_{8} {H}^{8} + {E}_{10} {H}^{10} \qquad ( 4 )$$

The numerical value embodiments of the present invention will be shown below. In the numerical value embodiments, Rᵢ represents the radius of curvature of the ith surface from the object side, Dᵢ represents the thickness and air space of the ith optical material from the object side, and Nᵢ and Vᵢ represent the refractive index and Abbe number, respectively, of the ith optical material from the object side.

(Numerical Value Embodiment 1)

| | | | |
|---|---|---|---|
| fe = 30.59 mm | FN0 = 1:5.0 | 2ω = 60.0° | m = −0.18898 |
| R₁ = 16.345 | D₁ = 1.84 | N₁ = 1.772 | ν₁ = 49.6 |
| R₂ = 36.801 | D₂ = 1.43 | | |
| R₃ = −44.460 | D₃ = 2.20 | N₂ = 1.640 | ν₂ = 34.5 |
| R₄ = 22.916 | D₄ = 2.67 | | |
| R₅ = (stop) | D₅ = 0 | | |
| R₆ = 19.185 | D₆ = 6.27 | N₃ = 1.772 | ν₃ = 49.6 |
| R₇ = −19.268 | D₇ = 0.37 | | |
| R₈ = −13.643 | D₈ = 5.57 | N₄ = 1.847 | ν₄ = 23.8 |
| R₉ = −18.197 | D₉ = 7.74 | | |
| R₁₀ = −11.533 | D₁₀ = 1.00 | N₅ = 1.583 | ν₅ = 30.2 |
| R₁₁ = −28.507 | | | |

Coefficients of Anamorphic Surface

| | | | |
|---|---|---|---|
| R₁₀ = −11.533 | k_{y} = 3.390 × 10⁻¹ | B₄ = −9.098 × 10⁻⁶ | B₆ = 5.224 × 10⁻⁸ |
| | D₂ = −2.802 × 10⁻³ | D₄ = 3.161 × 10⁻⁵ | D₆ = −2.144 × 10⁻⁷ |

(Numerical Value Embodiment 2)

| | | | |
|---|---|---|---|
| fe = 31.50 mm | FN0 = 1:5.0 | 2ω = 58.6° | m = −0.18898 |
| R₁ = 10.889 | D₁ = 3.66 | N₁ = 1.697 | ν₁ = 55.5 |
| R₂ = 26.983 | D₂ = 0.94 | | |
| R₃ = −54.632 | D₃ = 0.95 | N₂ = 1.699 | ν₂ = 30.1 |
| R₄ = 15.637 | D₄ = 0.70 | | |
| R₅ = (stop) | D₅ = 0.55 | | |
| R₆ = 20.973 | D₆ = 7.99 | N₃ = 1.786 | ν₃ = 44.2 |
| R₇ = −28.060 | D₇ = 3.38 | | |
| R₈ = −8.800 | D₈ = 2.40 | N₄ = 1.583 | ν₄ = 30.2 |
| R₉ = −13.649 | | | |

Coefficients of Anamorphic Surface

| | | |
|---|---|---|
| R₈ = −8.800 | | |
| k_{y} = 3.384 × 10⁻² | B₄ = −4.253 × 10⁻⁵ | B₆ = −3.644 × 10⁻⁷ |
| B₈ = −7.350 × 10⁻⁹ | B₁₀ = −1.898 × 10⁻¹⁰ | |
| D₂ = −3.132 × 10⁻³ | D₄ = 3.611 × 10⁻⁵ | D₆ = 1.896 × 10⁻⁷ |
| D₈ = 1.458 × 10⁻⁸ | D₁₀ = −4.639 × 10⁻¹⁰ | |

(Numerical Value Embodiment 3)

| | | | |
|---|---|---|---|
| fe = 28.94 mm | FN0 = 1:5.0 | 2ω = 57.1° | m = −0.16535 |
| R₁ = 9.798 | D₁ = 1.80 | N₁ = 1.772 | ν₁ = 49.6 |
| R₂ = 32.531 | D₂ = 1.43 | | |
| R₃ = −83.772 | D₃ = 1.00 | N₂ = 1.722 | ν₂ = 29.2 |
| R₄ = 11.750 | D₄ = 0.66 | | |
| R₅ = (stop) | D₅ = 0.95 | | |
| R₆ = 24.462 | D₆ = 6.66 | N₃ = 1.772 | ν₃ = 49.6 |
| R₇ = −33.061 | D₇ = 4.90 | | |
| R₈ = −6.566 | D₈ = 1.14 | N₄ = 1.530 | ν₄ = 55.5 |
| R₉ = −8.085 | | | |

Coefficients of Rotation-symmetrical Aspherical
Surface

| | | |
|---|---|---|
| R₈ = −6.566 | | |
| K = −2.160 × 10⁻¹ | E₄ = −9.555 × 10⁻⁵ | E₆ = −1.765 × 10⁻⁶ |
| E₈ = 3.462 × 10⁻⁵ | E₁₀ = −5.333 × 10⁻¹⁰ | |

Coefficients of Anamorphic Surface

| | | |
|---|---|---|
| R₉ = −8.085 | | |
| k_{y} = −1.379 × 10⁻¹ | B₄ = −2.592 × 10⁻⁵ | B₆ = −1.313 × 10⁻⁷ |
| B₈ = 7.835 × 10⁻⁹ | B₁₀ = 1.952 × 10⁻¹⁰ | |
| D₂ = 1.602 × 10⁻³ | D₄ = −4.808 × 10⁻⁵ | D₆ = 2.895 × 10⁻⁶ |
| D₈ = −6.418 × 10⁻⁸ | D₁₀ = 4.471 × 10⁻¹⁰ | |

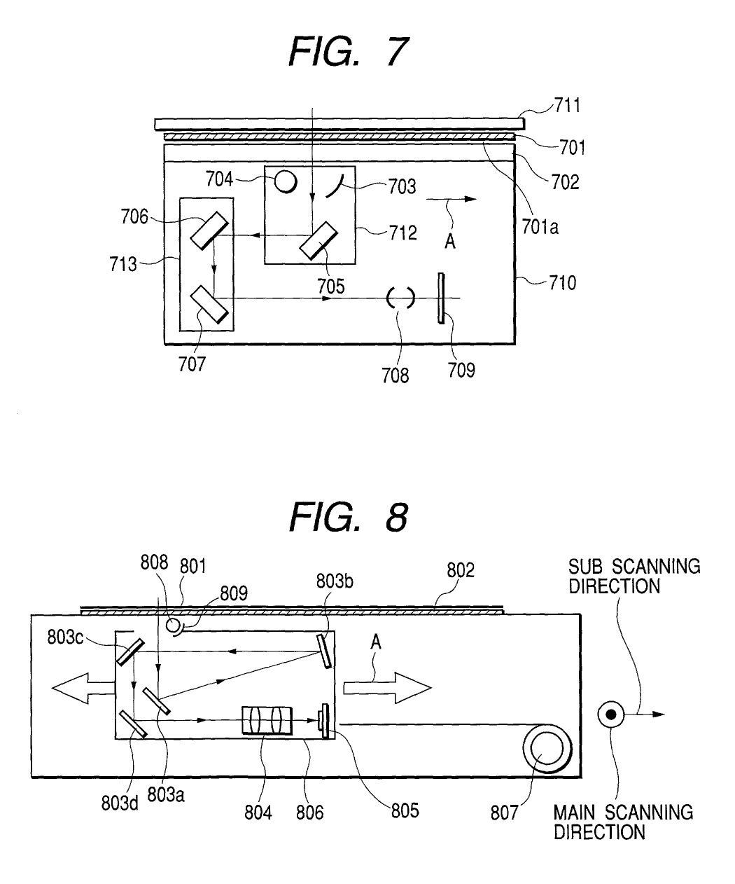

FIG. 7 is a schematic view of the essential portions of Embodiment when the imaging lens according to any one of Numerical Value Embodiments 1, 2 and 3 of the present invention is used in an image reading apparatus (image scanner) having a 1:2 scanning optical system.

In FIG. 7, an original stacking table 702 formed of transparent glass is disposed in the upper open portion of a housing 710. An original 701 is placed, and the original 701 is covered with a pressure plate 711, whereby the original 701 is fixed. As the order in which the original 701 is read, a xenon lamp 704 which is a light source first emits light and illuminates the surface of the original 701.

The xenon lamp 704 has a light emitting window called an aperture formed in the side of the tube thereof, and has its direction and shape set such that a beam is applied from the aperture toward the original 701. Also, in order to make the illumination more efficient and improve the quality of image, a reflecting member (reflector) 703 is disposed near the xenon lamp 704, and a beam which does not directly travel from the xenon lamp 704 toward the reading position for the original 701 is picked up to thereby enhance the illuminating efficiency. As the reflecting member 703, an appropriate shape is set as by making chiefly a metal member into a mirror surface. These are made into an integral structure as a first mirror bed 712, and are adapted to be scanned in the direction of arrow A (the sub scanning direction) along the surface of the original 701.

The beam having irradiated the original 701 is reflected by this original 701 and travels toward a first mirror 705. This reflected light includes the image information of the original 701, and a second mirror 706 and a third mirror 707 are disposed to direct this beam to a photoelectric conversion element 709 as reading means. The second mirror 706 and the third mirror 707 are also made into an integral structure (a symmetrical mirror) and is constituted by a second mirror bed 713.

Design is made such that to scan (read) the original, as the first mirror bed 712 scans the original 701 by a motor, not shown, the second mirror bed 713 follows it at half its speed, whereby the optical distance between the original 701 being scanned and an imaging lens (reading lens) 708 is maintained. Thus, the beam from the original 701 is imaged on the surface of the photoelectric conversion element 709 disposed in a conjugate relation, by the imaging lens 708.

This photoelectric conversion element 709 comprises a one-dimensional line sensor (CCD) or the like comprised of a plurality of elements arranged in the main scanning direction, and has its position prescribed so as to be along the main scanning direction on the surface of the original. Thereby, it becomes possible to once read the information on the main scanning direction of the original 701 placed on the original stacking table 702, and for the first and second mirror beds 712 and 713 to scan the original in succession to thereby read the information on the sub scanning direction of the original 701.

While in the present embodiment, the imaging lens of the present invention is applied to an image reading apparatus having a 1:2 scanning optical system, this is not restrictive, but like the above-described embodiment, the present invention can also be applied to an image reading apparatus of the integral type (flat bed type) shown, for example, in FIG. 8.

Also, while in the present embodiment, the imaging lens of the present invention is applied to an image scanner, this is not restrictive, but the imaging lens of the present invention can also be applied to an apparatus such as a digital copying machine or a facsimile apparatus.

According to the present invention, as previously described, there can be achieved an imaging lens in which at least one of a plurality of lenses constituting the imaging lens is comprised of an anamorphic lens and each element is appropriately set so as to satisfy the conditional expressions, thereby being capable of reading image information highly accurately even if there are changes in environmental conditions such as temperature, humidity and atmospheric pressure, and an image reading apparatus using the same.

What is claimed is:

1. An imaging lens for imaging the image information of an original on reading means, characterized in that at least one of a plurality of lenses constituting said imaging lens is a lens anamorphic with respect to the optical axis thereof, and when the temperature change factor dN/dT (1/° C.) of the refractive index dT of said anamorphic lens for e-line at the use temperature dT is defined as C_{T}, and the focal length (mm) of the anamorphic lens for e-line is defined as fₐₙₘ, the condition that
$$\vert \frac{{C}_{T}}{{f}_{a n m}} \vert \leq 4.30 \times {10}^{- 6}$$
is satisfied.

2. An imaging lens according to claim 1, characterized in that when the focal length (mm) of the total system of the imaging lens for e-line is defined as fall, said anamorphic lens satisfies the condition that
$$\vert \frac{{f}_{a l l}}{{f}_{a n m}} \vert \leq 1.10 .$$

3. An imaging lens according to claim 1, characterized in that when at the maximum angle of field of said imaging lens, the refractive power in the sub scanning direction for e-line at a position whereat a principal ray of a maximum angle of field passes through the incidence surface of the anamorphic lens is defined as φ₁ₛ, and the refractive power in the sub scanning direction for e-line at a position whereat the principal ray of the maximum angle of field passes through the emergence surface of the anamorphic lens is defined as φ₂ₛ, and the refractive power in the main scanning direction for e-line at the position whereat the principal ray of the maximum angle of field passes through the incidence surface of the anamorphic lens is defined as φ₁ₘ, and the refractive power in the main scanning direction for e-line at the position whereat the principal ray of the maximum angle of field passes through the emergence surface of the anamorphic lens is defined as φ₂ₘ, and the lens thickness of the anamorphic lens on the optical axis thereof is defined as d, said anamorphic lens satisfies the condition that

|fₐₙₘ((φ₁ₛ+φ₂ₛ−dφ₁ₛφ₂ₛ)−(φ₁ₘ+φ₂ₘ−dφ₁ₘφ₂ₘ))|≦0.33.

4. An image reading apparatus using an imaging lens according to any one of claims 1 to 3 to form the image information of the original on the surface of the reading means.
